(19) United States
(12) Patent Application Publication
(10) Pub. No.: US 2026/0046759 A1
(43) Pub. Date: Feb. 12, 2026

(54) MULTICAST CONFIGURATION UPDATE

(71) Applicant: LG ELECTRONICS INC., Seoul (KR)

(72) Inventor: Sangwon KIM, Seoul (KR)

(73) Assignee: LG ELECTRONICS INC., Seoul (KR)

(21) Appl. No.: 19/099,688

(22) PCT Filed: Jul. 27, 2023
(86) PCT No.: PCT/KR2023/010896

§ 371 Date: Jan. 29, 2025

Related U.S. Application Data
(60) Provisional application No. 63/394,635, filed on Aug. 3, 2022.

(51) Int. Cl. H04W 48/20; H04W 76/27; H04W 76/40

(52) U.S. Cl. CPC H04W 48/20; H04W 76/27; H04W 76/40

(57) ABSTRACT

A method and apparatus for multicast configuration update is provided. A wireless device receives a multicast configuration for a multicast session, and receives the multicast session based on the multicast configuration on a first serving cell while in an inactive state. After performing a cell reselection to camp on a second serving cell, if the multicast configuration is not available for the second serving cell, the wireless device initiates a connection resume procedure.

### CROSS-REFERENCE TO RELATED APPLICATIONS

This application is the National Stage filing under 35 U.S.C. 371 of International Application No. PCT/KR2023/010896, filed on Jul. 27, 2023, which claims the benefit of U.S. Provisional Application No. 63/394,635 filed on Aug. 3, 2022, the contents of which are all hereby incorporated by reference herein in their entireties.

### TECHNICAL FIELD

The present disclosure relates to multicast configuration update.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

5G Multicast and Broadcast Services (MBS) is an attempt at combining the world of broadcast services with the voice/data world of cellular mobile communication. Operators want additional revenue streams and hence, are looking at including broadcast services to their fleet of offerings. Consumers are looking at additional ways of remaining hooked to their mobile screens in a cost-effective manner and live TV is an obvious extension.

### SUMMARY

In an aspect, a method performed by a wireless device adapted to operate in a wireless communication system is provided. The method comprises receiving a multicast configuration for a multicast session, receiving the multicast session based on the multicast configuration on a first serving cell while in an inactive state, performing a cell reselection to camp on a second serving cell, and initiating a connection resume procedure based on the multicast configuration not being available for the second serving cell.

In another aspect, an apparatus for implementing the above method is provided.

The present disclosure may have various advantageous effects.

For example, the UE can keep receiving the multicast session after entering RRC_CONNECTED state.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of UE to which implementations of the present disclosure are applied.

FIGS. 4 and 5 show an example of protocol stacks in a 3GPP based wireless communication system to which implementations of the present disclosure are applied.

FIG. 6 shows a frame structure in a 3GPP based wireless communication system to which implementations of the present disclosure are applied.

FIG. 7 shows a data flow example in the 3GPP NR system to which implementations of the present disclosure are applied.

FIG. 8 shows an example of a method performed by a wireless device to which implementations of the present disclosure are applied.

FIG. 9 shows an example of a method performed by a base station serving a second serving cell to which implementations of the present disclosure are applied.

FIG. 10 shows an example of validity area to which implementations of the present disclosure are applied.

FIG. 11 shows an example of change notification to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in Downlink (DL) and SC-FDMA in Uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

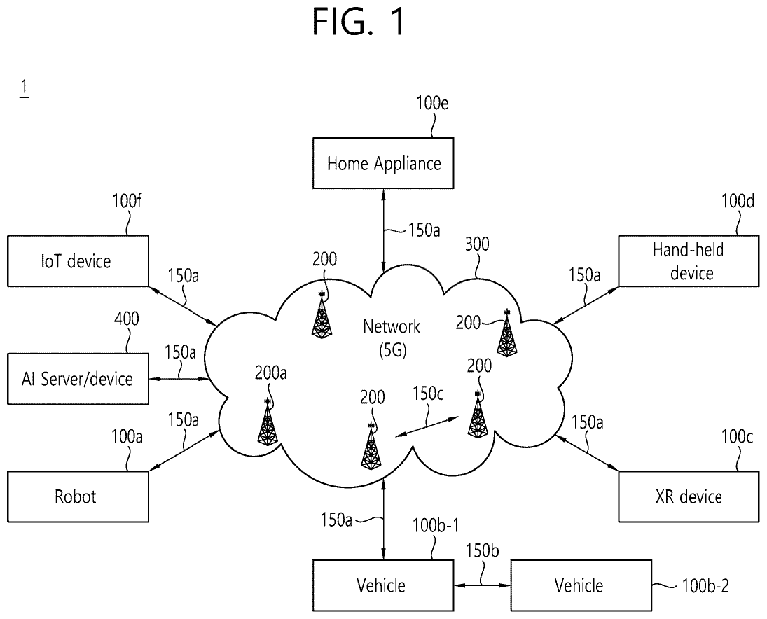

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include Narrow Band IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

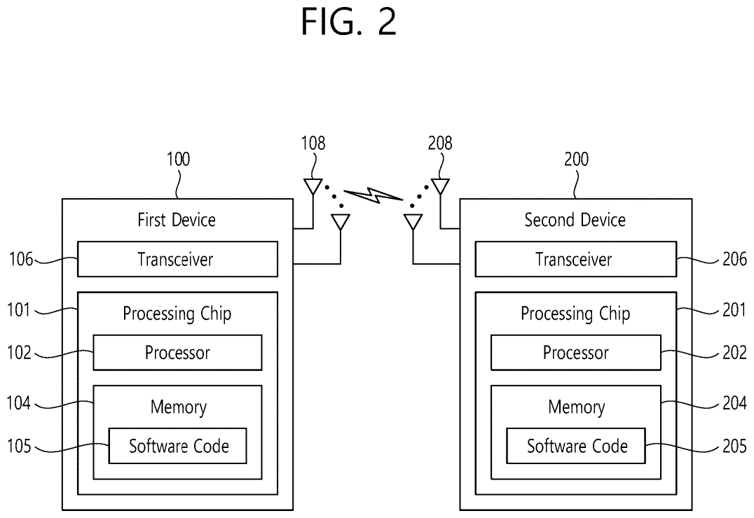

FIG. 2 shows an example of wireless devices to which implementations of the present disclosure are applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

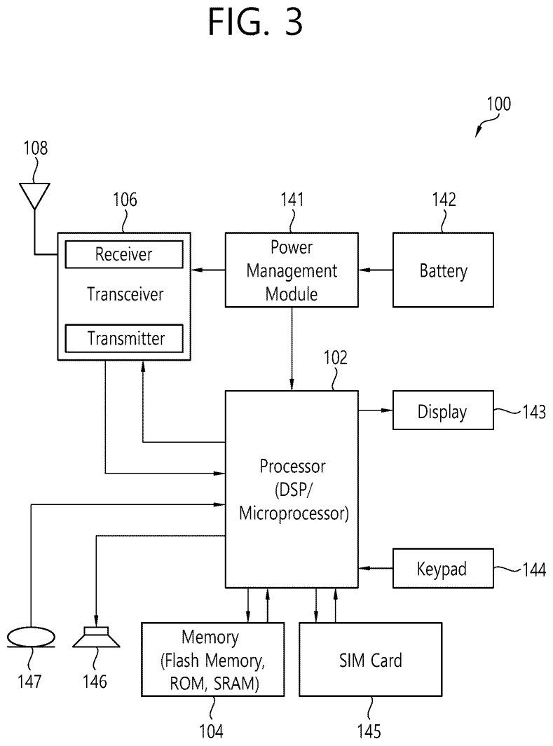

FIG. 3 shows an example of UE to which implementations of the present disclosure are applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

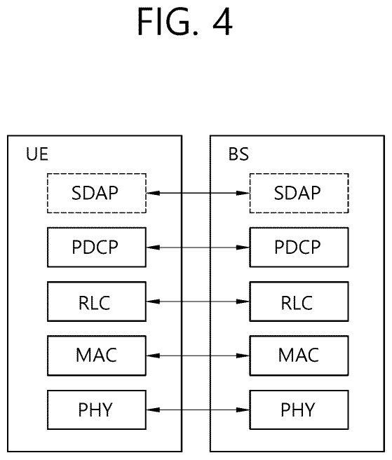

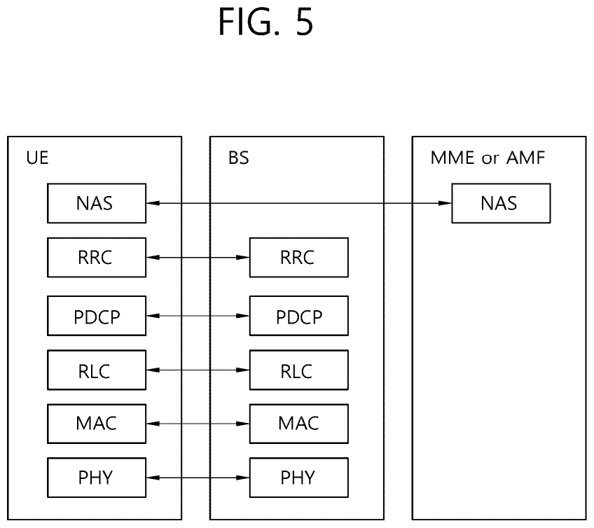

FIGS. 4 and 5 show an example of protocol stacks in a 3GPP based wireless communication system to which implementations of the present disclosure are applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM). Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

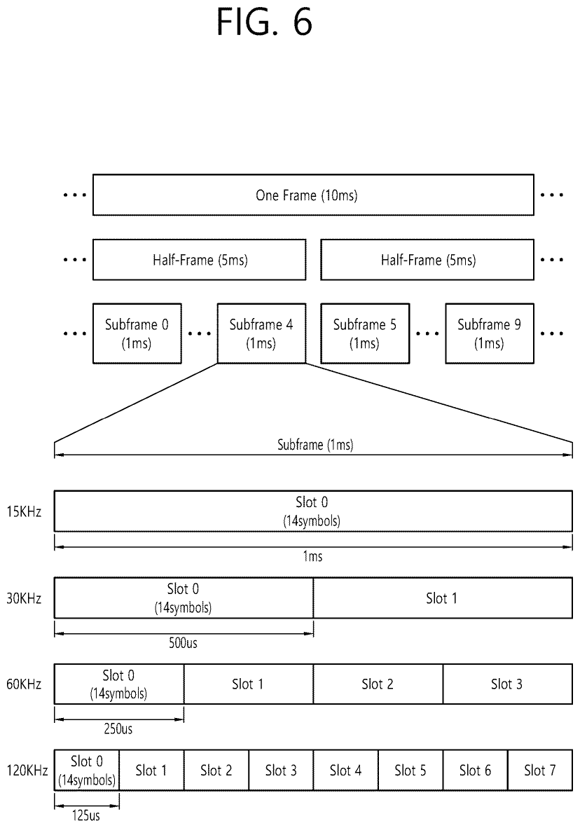

FIG. 6 shows a frame structure in a 3GPP based wireless communication system to which implementations of the present disclosure are applied.

The frame structure shown in FIG. 6 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 KHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0) and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i-1}, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL Component Carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell (SpCell). The configured set of serving cells for a UE therefore always consists of one PCell and one or more SCells. For Dual Connectivity (DC) operation, the term SpCell refers to the PCell of the Master Cell Group (MCG) or the Primary SCell (PSCell) of the Secondary Cell Group (SCG). An SpCell supports Physical Uplink Control Channel (PUCCH) transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

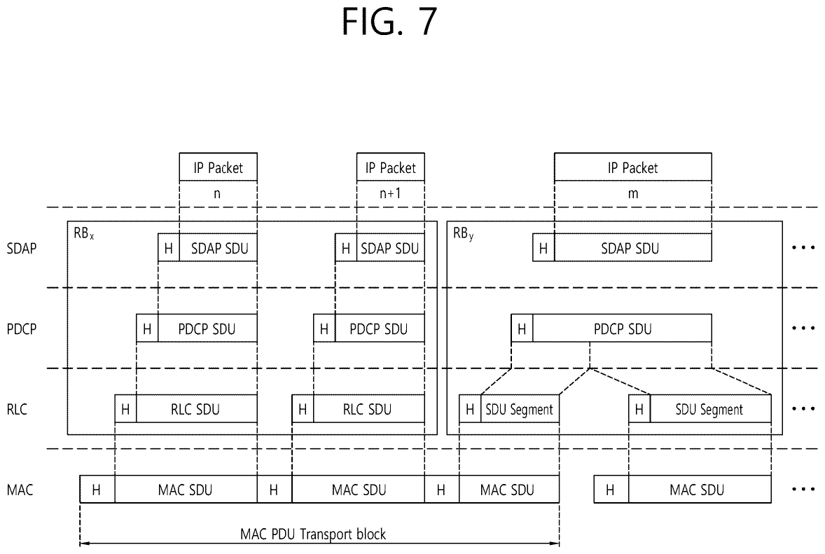

FIG. 7 shows a data flow example in the 3GPP NR system to which implementations of the present disclosure are applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

NR system enables resource efficient delivery of Multicast/Broadcast Services (MBS).

For broadcast communication service, the same service and the same specific content data are provided simultaneously to all UEs in a geographical area (i.e., all UEs in the broadcast service area are authorized to receive the data). A broadcast communication service is delivered to the UEs using a broadcast session. A UE can receive a broadcast communication service in RRC_IDLE, RRC_INACTIVE and RRC_CONNECTED state.

For multicast communication service, the same service and the same specific content data are provided simultaneously to a dedicated set of UEs (i.e., not all UEs in the multicast service area are authorized to receive the data). A multicast communication service is delivered to the UEs using a multicast session. A UE can receive a multicast communication service in RRC_CONNECTED state with mechanisms such as Point-To-Point (PTP) and/or Point-to-Multipoint (PTM) delivery. HARQ feedback/retransmission can be applied to both PTP and PTM transmission. Multicast service is described in detail.

There are two delivery modes:
5GC shared MBS traffic delivery;
5GC individual MBS traffic delivery.

If the gNB node supports MBS, the network may use the 5GC Shared MBS traffic delivery in which case an MBS session resource context for a multicast session is setup in the gNB when the first UE joins the multicast session.

For MBS shared delivery mode, shared NG-U resources are used to provide MBS user data to the gNB. The gNB node initiates the multicast distribution establishment procedure towards the 5GC, to allocate shared NG-U resources for a multicast session. In case multiple MBS session areas are associated with the MBS session for location dependent MBS services, multiple NG-U shared resources are established for the same multicast session per MBS Area Session ID served by the gNB.

A shared NG-U resource applies one of the following transport options:
unicast transport;
multicast transport.

For 5GC shared MBS traffic delivery an MBS session resource comprises one or several MBS Radio Bearers (MRBs). If minimization of data loss is applied for a given MRB, synchronization of allocation of PDCP SNs is applied by either or a combination of the following methods:
derivation of the PDCP SNs by means of a DL MBS QFI sequence number provided on NG-U;
deployment of a shared NG-U termination at NG-RAN, shared among gNBs, which comprises a common entity for assignment of PDCP SNs.

Synchronization in terms of MBS QoS flow to MRB mapping among gNBs is achieved by means of network implementation.

If PDCP SNs are derived from a DL MBS QFI sequence number provided on NG-U and only one QoS Flow is mapped to an MRB, the gNB may set the PDCP SN of PDCP PDU to the value of the DL MBS QFI sequence number provided with the received packet over NG-U. If PDCP SNs are derived from a DL MBS QFI sequence number provided on NG-U and multiple QoS flows are mapped to an MRB, the gNB may derive the PDCP SN of the PDCP PDU from the sum of the DL MBS QFI sequence numbers of the QoS flows mapped to this MRB.

A UE can receive data of MBS multicast session only in RRC_CONNECTED state. If the UE which joined a multicast session is in RRC_CONNECTED state and when the multicast session starts, the gNB sends RRC reconfiguration message with relevant MBS configuration for the multicast session to the UE and there is no need for separate session activation notification for this UE.

When there is (temporarily) no data to be sent to the UEs for a multicast session, the gNB may move the UE to RRC IDLE/INACTIVE state. gNBs supporting MBS use a group notification mechanism to notify the UEs in RRC IDLE/INACTIVE state when a multicast session has been activated by the Core Network (CN) or the gNB has multicast session data to deliver. Upon reception of the group notification, the UEs reconnect to the network. The group notification is addressed with Paging Radio Network Temporary Identity (P-RNTI) on PDCCH, and the paging channels are monitored by the UE. Paging message for group notification contains MBS session ID which is utilized to page all UEs in RRC_IDLE and RRC_INACTIVE states that joined the associated MBS multicast session, i.e., UEs are not paged individually. The UE stops monitoring for group notifications related to a specific multicast session once the UE leaves this multicast session.

If the UE in RRC_IDLE state that joined an MBS multicast session is camping on gNB not supporting MBS, the UE may be notified about multicast session activation or data availability by CN-initiated paging where CN pages each UE individually. If the UE in RRC_INACTIVE state that joined MBS multicast session is camping on gNB not supporting MBS, the UE may be notified about data availability by RAN-initiated paging.

The gNB may use RRC reconfiguration message to configure or reconfigure a multicast MRB, e.g., add/release/modify the MRB's RLC entities. In order to minimize the data loss due to MRB reconfiguration, gNB may configure UE to send a PDCP status report during reconfiguration which results in MRB type change.

For multicast service, gNB may deliver multicast MBS data packets using the following methods:
PTP transmission: gNB individually delivers separate copies of MBS data packets to each UEs independently, i.e., gNB uses UE-specific PDCCH with Cyclic Redundancy Check (CRC) scrambled by UE-specific RNTI (e.g., Cell RNTI (C-RNTI)) to schedule UE-specific PDSCH which is scrambled with the same UE-specific RNTI.
PTM transmission: gNB delivers a single copy of MBS data packets to a set of UEs, e.g., gNB uses group-common PDCCH with CRC scrambled by group-common RNTI to schedule group-common PDSCH which is scrambled with the same group-common RNTI.

If a UE is configured with both PTM and PTP transmissions, a gNB dynamically decides whether to deliver multicast data by PTM leg and/or PTP leg for a given UE based on the protocol stack, based on information such as MBS session QoS requirements, number of joined UEs, UE individual feedback on reception quality, and other criteria. The same QoS requirements apply regardless of the decision.

It has been studied that the UE in RRC_IDLE state and/or RRC_INACTIVE state can receive the multicast session. The UE in RRC_IDLE state and/or RRC_INACTIVE state may receive the multicast session on a BWP dedicated multicast, i.e., multicast BWP. The multicast BWP may be called a multicast Common Frequency Resource (CFR).

The multicast CFR may not be overlapped with the initial BWP. The initial BWP is used to perform initial access process. The UE may perform cell reselection based on the measurement on the initial BWP. That is, the UE may measure the initial BWP of cells, and compare the measurement results of the initial BWP of each cell. If the measurement result of the initial BWP of a specific cell satisfies a specific condition, the UE may reselect the specific cell.

If the UE performs cell reselection based on the measurement on the initial BWP, the receiving quality of the multicast session transmitted in the multicast CFR cannot be guaranteed. If the receiving quality of the multicast session in RRC_IDLE state and/or RRC/INACTIVE state is not satisfactory (e.g., not good enough), the UE needs to enter RRC_CONNECTED state to receive the multicast session using HARQ re-transmission.

Furthermore, even though a cell supports the NR multicast transmission, the cell may or may not support the multicast reception of the UE in RRC_IDLE state and/or RRC/INACTIVE state depending on the congestion level. Therefore, a neighbor cell within RAN-based Notification Area (RNA), which does not support the multicast reception of the UE in RRC_IDLE state and/or RRC/INACTIVE state, may stop the multicast transmission for the UE in RRC_IDLE state and/or RRC/INACTIVE state for a certain multicast session, before the UE receiving the multicast session camps on the cell. If so, the UE cannot keep receiving the multicast session in RRC_IDLE state and/or RRC/INACTIVE state after cell re-selection.

For example, the RRC resume message may include all configurations required to receive the multicast session in RRC/INACTIVE state. If the gNB knows that the RRC resume is initiated solely to acquire the PTM configuration, the gNB may provide the PTM configuration via the RRC Resume message for the multicast session(s) that the UE has joined. However, if the RRC Resume message is used to provide the PTM configuration, the RRC resume procedure will continue even after the PTM configuration is transmitted, needlessly transitioning the UE to RRC_CONNECTED state.

According to embodiments of the present disclosure, for a UE in RRC_IDLE state and/or RRC_INACTIVE state, which is receiving, has joined, or wants to receive a multicast session, if the UE has no configuration on the multicast session which is valid in the current serving cell, the UE may initiate RRC connection establishment procedure and/or RRC connection resume procedure.

For example, if the UE has no PTM configuration on the multicast session which is valid in the current serving cell, the UE in RRC_INACTIVE state may transmit an RRC Resume Request message, and receive an RRC Resume message, after which the UE transitions to RRC_CONNECTED state. In RRC_CONNECTED state, the UE may receive a new PTM configuration, and receive the multicast session based on the new PTM configuration in RRC_CONNECTED state.

For another example, if the UE has no PTM configuration on the multicast session which is valid in the current serving cell, the UE in RRC_INACTIVE state may transmit an RRC Resume Request message, and receive an RRC Release message with suspend configuration. The UE may request transmission of the PTM configuration via the RRC Resume Request message, and may receive the PTM configuration via the RRC Release message with suspend configuration. That is, to avoid unnecessary state transitions, the PTM configuration may be received via a sequence of the RRC Resume Request message-RRC Release message with suspend configuration that allows the UE in RRC_INACTIVE state to request and acquire the PTM configuration without transitioning to RRC_CONNECTED state. The UE may continue to receive the multicast session based on the new PTM configuration in RRC_INACTIVE state. This may be a good alternative to periodically broadcasting the PTM configuration, especially when the gNB does not know which multicast sessions UEs are receiving in RRC_INACTIVE state from neighbor cells.

According to embodiments of the present disclosure, a new resume cause may be defined/introduced, such as ‘PTM configuration’. Based on the RRC Resume Request message including the new resume cause such as ‘PTM configuration’, the network may decide to transmit an RRC Resume message and/or an RRC Release message that includes the PTM configuration in response to the UE's request.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

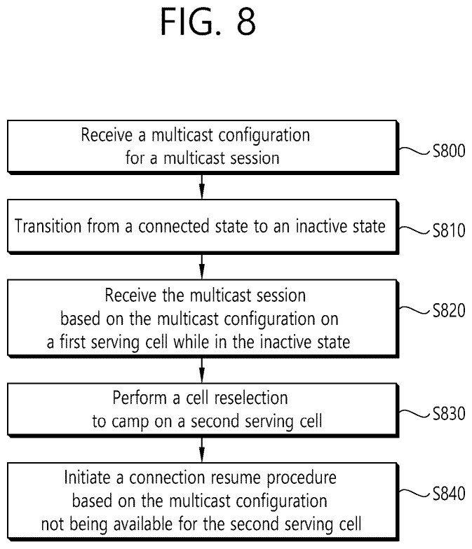

FIG. 8 shows an example of a method performed by a wireless device to which implementations of the present disclosure are applied.

In step S800, the method comprises receiving a multicast configuration for a multicast session.

In step S810, the method comprises transitioning from a connected state to an inactive state.

In step S820, the method comprises receiving the multicast session based on the multicast configuration on a first serving cell while in the inactive state.

In step S830, the method comprises performing a cell reselection to camp on a second serving cell.

In step S840, the method comprises initiating a connection resume procedure based on the multicast configuration not being available for the second serving cell.

In some implementations, the multicast configuration not being available for the second serving cell may comprise the multicast configuration not being valid in the second serving cell. For example, one of triggering conditions for initiation of the RRC connection resume procedure may be that the multicast configuration for the multicast session that the wireless device is receiving, has joined, or wants to receive is not valid in the serving cell.

In some implementations, the multicast configuration not being available for the second serving cell may comprise serving cell change from the first serving cell to the second serving cell while receiving the multicast session in the inactive state. For example, one of triggering conditions for initiation of the RRC connection resume procedure may be that the serving cell is changed while receiving a multicast session in RRC_INACTIVE state.

In some implementations, the multicast configuration not being available for the second serving cell may comprise a change notification for the multicast configuration being received. For example, one of triggering conditions for initiation of the RRC connection resume procedure may be that the change notification for the multicast configuration for the multicast session that the wireless device is receiving, has joined, or wants to receive is received.

In some implementations, the multicast configuration not being available for the second serving cell may comprise the multicast configuration not being provided via a common control channel that the wireless device can receive in the inactive state. For example, one of triggering conditions for initiation of the RRC connection resume procedure may be that the multicast configuration for the multicast session that the wireless device is receiving, has joined, or wants to receive is not provided via a common control channel that the wireless device can receive in RRC_INACTIVE state, e.g., Multicast Control Channel (MCCH) or BCCH.

In some implementations, a validity area of the multicast configuration may be the first serving cell. Or, a validity area of the multicast configuration may not be configured for the multicast session. In this case, the multicast configuration may be considered valid in the first serving cell only, and the multicast configuration may not be considered valid in the second serving cell.

For example, if the validity area of the multicast configuration is a single cell, or if the validity area of the multicast configuration is not configured for the multicast session that the wireless device is receiving, has joined, or wants to receive, the wireless device may consider the multicast configuration received from a serving cell is valid in the serving cell only. The wireless device may also consider the multicast configuration received from a previous serving cell is invalid after (re-)selecting a new serving cell which is different from the previous serving cell.

In some implementations, a validity area configuration for a validity area of the multicast configuration may be received. For example, the validity area configuration for a validity area of the multicast configuration may be received on the first serving cell. The validity area configuration may be included in the multicast configuration. Or, the validity area configuration may be included in an RRC Release message with a suspend configuration. In this case, the multicast configuration may be considered valid based on a serving cell belonging to the validity area of the multicast configuration. The multicast configuration may not be considered valid based on a serving cell not belonging to the validity area of the multicast configuration.

For example, if the validity area of the multicast configuration is configured for the multicast session that the wireless device is receiving, has joined, or wants to receive, the wireless device may consider the multicast configuration is valid if the serving cell of the wireless device belongs to the validity area. The wireless device may also consider the multicast configuration is invalid if the serving cell of the wireless device does not belong to the validity area.

In some implementations, the connection resume procedure may comprise transmitting a connection resume request message including a new resume cause on the second serving cell. The connection resume procedure may comprise setting the new resume cause based on the multicast configuration not being available for the second serving cell. The new resume cause may be ‘multicast configuration’. For example, if one of the triggering conditions mentioned above is met, the wireless device in RRC_INACTIVE state may initiate RRC connection resume procedure, by setting the resume cause to the new resume cause, e.g., ‘multicast configuration’, and transmitting an RRC Resume Request message including the new resume cause.

In some implementations, the new resume cause may be informed to an upper layer. For example, (RRC layer of) the wireless device may inform NAS layer of the wireless device that the resume cause is ‘multicast configuration’. In addition, (RRC layer of) the wireless device may inform NAS layer of the wireless device that the RRC connection needs to be resumed to receive the multicast configuration for the multicast session.

In some implementations, a new access type related to transitioning from the inactive state to the connected state to receive the multicast configuration for the multicast session may be defined. For example, the new access type may be ‘multicast configuration’. In addition, (RRC layer of) the wireless device may inform NAS layer of the wireless device that the access type is ‘multicast configuration’.

For example, upon initiating the connection resume procedure, e.g., transmitting an RRC Resume Request message, the wireless device may receive an RRC Resume message in response to the RRC Resume Request message. The RRC Resume Request message may include the new PTM configuration. The wireless device may receive the multicast session on the second serving cell based on the new PTM configuration in RRC_CONNECTED state.

For example, upon initiating the connection resume procedure, e.g., transmitting an RRC Resume Request message, the wireless device may receive an RRC Release message with suspend configuration in response to the RRC Resume Request message. The RRC Release message with suspend configuration message may include the new PTM configuration. The wireless device may continue to receive the multicast session on the second serving cell based on the new PTM configuration in RRC_INACTIVE state, without state transition to RRC_CONNECTED state.

In some implementations, the wireless device may be in communication with at least one of a mobile device, a network, and/or autonomous vehicles other than the wireless device.

FIG. 8 has described an embodiment of the present disclosure in which, for a UE which is receiving, has joined, or wants to receive a multicast session, the UE in RRC_INACTIVE state initiates RRC connection resume procedure if the UE has no multicast configuration for the multicast session which is valid in the current serving cell. However, it is merely exemplarily, and the present disclosure may be applied to an embodiment in which, for a UE which is receiving, has joined, or wants to receive a multicast session, the UE in RRC_IDLE state initiates RRC connection establishment procedure if the UE has no multicast configuration for the multicast session which is valid in the current serving cell.

For example, the wireless device may transition from a connected state (e.g., RRC_CONNECTED state) to an idle state (e.g., RRC_IDLE state). The wireless device may receive the multicast session based on the multicast configuration on a first serving cell while in the idle state. The wireless device performs a cell reselection to camp on a second serving cell, and initiates a connection establishment procedure based on the multicast configuration not being available for the second serving cell. That is, if the wireless device is receiving, has joined, or wants to receive a multicast session in RRC_IDLE state, and if the wireless device has no multicast configuration for the multicast session which is valid in the current serving cell, the wireless device in the idle state (e.g., RRC_IDLE state) initiates a connection establishment procedure (e.g., RRC connection establishment procedure).

In some implementations, the connection establishment procedure may comprise transmitting a connection establishment request message including a new establishment cause on the second serving cell. The connection establishment procedure may comprise setting the new establishment cause based on the multicast configuration not being available for the second serving cell. The new establishment cause may be ‘multicast configuration’. For example, if one of the triggering conditions mentioned above is met, the wireless device in RRC_IDLE state may initiate RRC connection establishment procedure, by setting the establishment cause to the new establishment cause, e.g., ‘multicast configuration’, and transmitting an RRC Setup Request message including the new establishment cause.

In some implementations, the new establishment cause may be informed to an upper layer. For example, (RRC layer of) the wireless device may inform NAS layer of the wireless device that the establishment cause is ‘multicast configuration’. In addition, (RRC layer of) the wireless device may inform NAS layer of the wireless device that the RRC connection needs to be established to receive the multicast configuration for the multicast session.

In some implementations, a new access type related to transitioning from the idle state to the connected state to receive the multicast configuration for the multicast session may be defined. For example, the new access type may be ‘multicast configuration’. In addition, (RRC layer of) the wireless device may inform NAS layer of the wireless device that the access type is ‘multicast configuration’.

Furthermore, the method in perspective of the wireless device described above in FIG. 8 may be performed by the first wireless device 100 shown in FIG. 2 and/or the UE 100 shown in FIG. 3.

The wireless device comprises at least one transceiver, at least one processor, and at least one memory operably connectable to the at least one processor and storing instructions that, based on being executed by the at least one processor, perform the method described in FIG. 8.

More specifically, the wireless device receives a multicast configuration for a multicast session.

The wireless device transitions from a connected state to an inactive state.

The wireless device receives the multicast session based on the multicast configuration on a first serving cell while in the inactive state.

The wireless device performs a cell reselection to camp on a second serving cell.

The wireless device initiates a connection resume procedure based on the multicast configuration not being available for the second serving cell.

In some implementations, the multicast configuration not being available for the second serving cell may comprise the multicast configuration not being valid in the second serving cell. For example, one of triggering conditions for initiation of the RRC connection resume procedure may be that the multicast configuration for the multicast session that the wireless device is receiving, has joined, or wants to receive is not valid in the serving cell.

In some implementations, the multicast configuration not being available for the second serving cell may comprise serving cell change from the first serving cell to the second serving cell while receiving the multicast session in the inactive state. For example, one of triggering conditions for initiation of the RRC connection resume procedure may be that the serving cell is changed while receiving a multicast session in RRC_INACTIVE state.

In some implementations, the multicast configuration not being available for the second serving cell may comprise a change notification for the multicast configuration being received. For example, one of triggering conditions for initiation of the RRC connection resume procedure may be that the change notification for the multicast configuration for the multicast session that the wireless device is receiving, has joined, or wants to receive is received.

In some implementations, the multicast configuration not being available for the second serving cell may comprise the multicast configuration not being provided via a common control channel that the wireless device can receive in the inactive state. For example, one of triggering conditions for initiation of the RRC connection resume procedure may be that the multicast configuration for the multicast session that the wireless device is receiving, has joined, or wants to receive is not provided via a common control channel that the wireless device can receive in RRC_INACTIVE state, e.g., MCCH or BCCH.

In some implementations, a validity area of the multicast configuration may be the first serving cell. Or, a validity area of the multicast configuration may not be configured for the multicast session. In this case, the multicast configuration may be considered valid in the first serving cell only, and the multicast configuration may not be considered valid in the second serving cell.

For example, if the validity area of the multicast configuration is a single cell, or if the validity area of the multicast configuration is not configured for the multicast session that the wireless device is receiving, has joined, or wants to receive, the wireless device may consider the multicast configuration received from a serving cell is valid in the serving cell only. The wireless device may also consider the multicast configuration received from a previous serving cell is invalid after (re-)selecting a new serving cell which is different from the previous serving cell.

In some implementations, a validity area configuration for a validity area of the multicast configuration may be received. For example, the validity area configuration for a validity area of the multicast configuration may be received on the first serving cell. The validity area configuration may be included in the multicast configuration. Or, the validity area configuration may be included in an RRC Release message with a suspend configuration. In this case, the multicast configuration may be considered valid based on a serving cell belonging to the validity area of the multicast configuration. The multicast configuration may not be considered valid based on a serving cell not belonging to the validity area of the multicast configuration.

For example, if the validity area of the multicast configuration is configured for the multicast session that the wireless device is receiving, has joined, or wants to receive, the wireless device may consider the multicast configuration is valid if the serving cell of the wireless device belongs to the validity area. The wireless device may also consider the multicast configuration is invalid if the serving cell of the wireless device does not belong to the validity area.

In some implementations, the connection resume procedure may comprise transmitting a connection resume request message including a new resume cause on the second serving cell. The connection resume procedure may comprise setting the new resume cause based on the multicast configuration not being available for the second serving cell. The new resume cause may be ‘multicast configuration’. For example, if one of the triggering conditions mentioned above is met, the wireless device in RRC_INACTIVE state may initiate RRC connection resume procedure, by setting the resume cause to the new resume cause, e.g., ‘multicast configuration’, and transmitting an RRC Resume Request message including the new resume cause.

In some implementations, the new resume cause may be informed to an upper layer. For example, (RRC layer of) the wireless device may inform NAS layer of the wireless device that the resume cause is ‘multicast configuration’. In addition, (RRC layer of) the wireless device may inform NAS layer of the wireless device that the RRC connection needs to be resumed to receive the multicast configuration for the multicast session.

In some implementations, a new access type related to transitioning from the inactive state to the connected state to receive the multicast configuration for the multicast session may be defined. For example, the new access type may be ‘multicast configuration’. In addition, (RRC layer of) the wireless device may inform NAS layer of the wireless device that the access type is ‘multicast configuration’.

For example, upon initiating the connection resume procedure, e.g., transmitting an RRC Resume Request message, the wireless device may receive an RRC Resume message in response to the RRC Resume Request message. The RRC Resume Request message may include the new PTM configuration. The wireless device may receive the multicast session on the second serving cell based on the new PTM configuration in RRC_CONNECTED state.

For example, upon initiating the connection resume procedure, e.g., transmitting an RRC Resume Request message, the wireless device may receive an RRC Release message with suspend configuration in response to the RRC Resume Request message. The RRC Release message with suspend configuration message may include the new PTM configuration. The wireless device may continue to receive the multicast session on the second serving cell based on the new PTM configuration in RRC_INACTIVE state, without state transition to RRC_CONNECTED state.

Furthermore, the method in perspective of the wireless device described above in FIG. 8 may be performed by control of the processor 102 included in the first wireless device 100 shown in FIG. 2 and/or by control of the processor 102 included in the UE 100 shown in FIG. 3.

A processing apparatus adapted to control a wireless device comprises at least one processor, and at least one memory operably connectable to the at least one processor. The at least one processor is adapted to perform the method described in FIG. 8.

Furthermore, the method in perspective of the wireless device described above in FIG. 8 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as Synchronous DRAM (SDRAM), ROM, Non-Volatile RAM (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory Computer-Readable Medium (CRM) stores instructions that, based on being executed by at least one processor, perform the method described in FIG. 8.

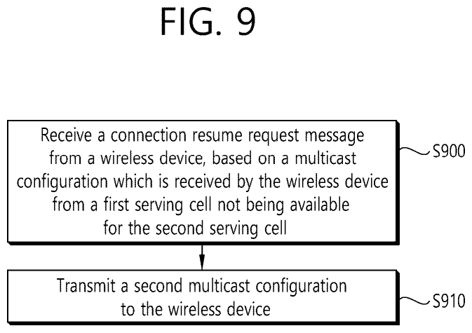

FIG. 9 shows an example of a method performed by a base station serving a second serving cell to which implementations of the present disclosure are applied.

In step S900, the method comprises receiving a connection resume request message from the wireless device, based on a multicast configuration which is received by the wireless device from a first serving cell not being available for the second serving cell.

In step S910, the method comprises transmitting a second multicast configuration to the wireless device.

Furthermore, the method in perspective of the base station serving a second serving cell described above in FIG. 9 may be performed by the second wireless device 200 shown in FIG. 2.

The base station comprises at least one transceiver, at least one processor, and at least one memory operably connectable to the at least one processor and storing instructions that, based on being executed by the at least one processor, perform the method described in FIG. 9.

More specifically, the base station receives a connection resume request message from the wireless device, based on a multicast configuration which is received by the wireless device from a first serving cell not being available for the second serving cell.

The base station transmits a second multicast configuration to the wireless device.

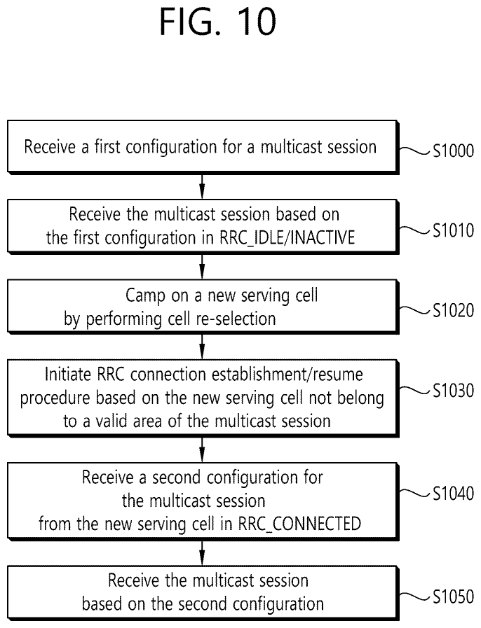

FIG. 10 shows an example of validity area to which implementations of the present disclosure are applied.

In step S1000, the UE receives a first configuration for a multicast session.

For example, the first configuration may include a validity area configuration. The validity area configuration may indicate one or more cell IDs. The first configuration may also include a Group Radio Network Temporary Identity (G-RNTI) related to the multicast session.

In step S1010, the UE receives the multicast session based on the first configuration in RRC_IDLE/INACTIVE state.

In step S1020, the UE camps on a new serving cell by performing cell re-selection procedure.

In step S1030, the UE initiates RRC connection establishment/resume procedure based on the new serving cell not belonging to a validity area of the multicast session.

For example, the UE may determine whether to establish/resume the RRC connection based on whether the new serving cell belongs to the validity area of the multicast session. If the new serving cell does not belong to the validity area of the multicast session, the UE may initiate RRC connection establishment/resume procedure. If the new serving cell belongs to the validity area of the multicast session, the UE may not initiate RRC connection establishment/resume procedure, and keep using the existing configuration (e.g., first configuration) for the multicast session.

In step S1040, the UE receives a second configuration for the multicast session from the new serving cell in RRC_CONNECTED.

In step S1050, the UE receives the multicast session based on the second configuration.

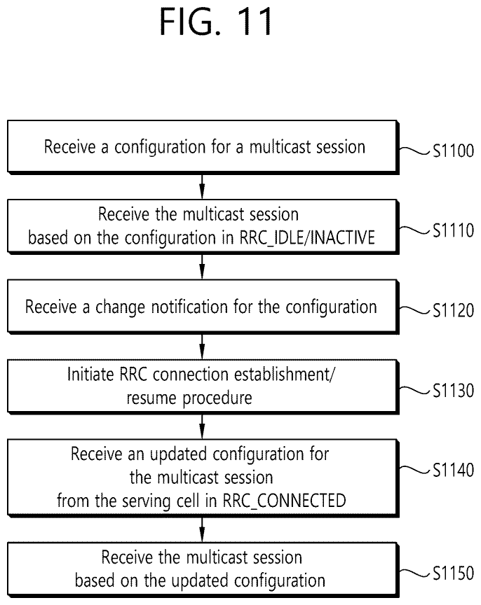

FIG. 11 shows an example of change notification to which implementations of the present disclosure are applied.

In step S1100, the UE receives a configuration for a multicast session.

For example, the configuration may include a G-RNTI related to the multicast session.

In step S1110, the UE receives the multicast session based on the configuration in RRC_IDLE/INACTIVE state.

In step S1120, the UE receives a change notification for the configuration.

In step S1130, upon receiving the change notification for the configuration, the UE initiates RRC connection establishment/resume procedure.

In step S1140, the UE receives an updated configuration for the multicast session from the serving cell in RRC_CONNECTED.

In step S1150, the UE receives the multicast session based on the updated configuration.

The present disclosure may have various advantageous effects.

For example, the UE can keep receiving the multicast session after entering RRC_CONNEECTED state.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-25. (canceled)

26. A method comprising:
receiving a multicast configuration for a multicast session;
transitioning from a connected state to an inactive state;
receiving the multicast session based on the multicast configuration on a first serving cell while in the inactive state;
performing a cell reselection to camp on a second serving cell; and
initiating a connection resume procedure based on the multicast configuration not being available for the second serving cell.

27. The method of claim 26, wherein the multicast configuration not being available for the second serving cell comprises the multicast configuration not being valid in the second serving cell.

28. The method of claim 26, wherein the multicast configuration not being available for the second serving cell comprises serving cell change from the first serving cell to the second serving cell while receiving the multicast session in the inactive state.

29. The method of claim 26, wherein the multicast configuration not being available for the second serving cell comprises a change notification for the multicast configuration being received.

30. The method of claim 26, wherein the multicast configuration not being available for the second serving cell comprises the multicast configuration not being provided via a common control channel that a wireless device can receive in the inactive state.

31. The method of claim 26, wherein a validity area of the multicast configuration is the first serving cell or is not configured for the multicast session.

32. The method of claim 31, wherein the multicast configuration is considered valid in the first serving cell only, and
wherein the multicast configuration is not considered valid in the second serving cell.

33. The method of claim 26, wherein a validity area configuration for a validity area of the multicast configuration is received.

34. The method of claim 33, wherein the multicast configuration is considered valid based on a serving cell belonging to the validity area of the multicast configuration.

35. The method of claim 33, wherein the multicast configuration is not considered valid based on a serving cell not belonging to the validity area of the multicast configuration.

36. The method of claim 33, wherein the validity area configuration is included in the multicast configuration.

37. The method of claim 33, wherein the validity area configuration is included in a Radio Resource Control (RRC) Release message with a suspend configuration.

38. The method of claim 26, wherein the connection resume procedure comprises transmitting a connection resume request message including a new resume cause on the second serving cell.

39. The method of claim 38, wherein the connection resume procedure comprises setting the new resume cause based on the multicast configuration not being available for the second serving cell.

40. The method of claim 38, wherein the new resume cause is ‘multicast configuration’.

41. The method of claim 38, wherein the new resume cause is informed to an upper layer.

42. The method of claim 26, wherein that a connection needs to be resumed to receive the multicast configuration for the multicast session is informed to an upper layer.

43. The method of claim 26, wherein a new access type related to transitioning from the inactive state to the connected state to receive the multicast configuration for the multicast session is informed to an upper layer.

44. A wireless device comprising:
at least one transceiver;
at least one processor; and
at least one memory operably connectable to the at least one processor and storing instructions that, based on being executed by the at least one processor, cause the wireless device to perform operations comprising:
receiving, via the at least one transceiver, a multicast configuration for a multicast session;
transitioning from a connected state to an inactive state;
receiving, via the at least one transceiver, the multicast session based on the multicast configuration on a first serving cell while in the inactive state;
performing a cell reselection to camp on a second serving cell; and
initiating a connection resume procedure based on the multicast configuration not being available for the second serving cell.

45. A base station serving a second serving cell comprising:
at least one transceiver;
at least one processor; and
at least one memory operably connectable to the at least one processor and storing instructions that, based on being executed by the at least one processor, cause the base station to perform operations comprising
receiving a connection resume request message from a wireless device, based on a multicast configuration which is received by the wireless device from a first serving cell not being available for the second serving cell; and
transmitting a second multicast configuration to the wireless device.
